(19) United States
(12) Patent Application Publication
(10) Pub. No.: US 2010/0124065 A1
(43) Pub. Date: May 20, 2010

(54) Led lamp with depending arms of led integral with glass housing

(76) Inventor: Ho-Hsin Chiu, Hsinchu City (TW)

Correspondence Address: BACON & THOMAS, PLLC, 625 SLATERS LANE, FOURTH FLOOR, ALEXANDRIA, VA, 22314-1176, US

(21) Appl. No.: 12/292,488

(22) Filed: Nov. 20, 2008

(51) Int. Cl. F21V 15/00

(52) U.S. Cl. 362/363

(57) ABSTRACT

An LED lamp includes a glass housing, an LED having two depending arms extending therefrom, a leg releasably secured to the depending arms, and an electrical socket releasably secured to both the leg and a base portion of the glass housing. The housing and the depending arms are formed integrally in a manufacturing process so that in case the LED lamp is malfunctioned, a replacement of both the LED and the glass housing can be made easy by removing the base portion of the glass housing from the socket without worrying of breaking the glass housing.

### BACKGROUND OF THE INVENTION

1. Field of Invention

The invention relates to LED (light-emitting diode) light sources and more particularly to an LED lamp having an LED with two depending arms being formed integrally with glass housing in the manufacturing process.

2. Description of Related Art

LEDs are renowned for their long life and their ability to resist shock. Also, an LED consumes much less electrical power than fluorescent lamps (i.e., energy saving). Therefore, LED lighting devices are gaining popularity worldwide.

A conventional type of LED lamp has an LED with two depending arms inserted into a leg which is again inserted into a socket. The socket is secured to a glass housing.

However, the well known LED lamp suffers from a disadvantage. In detail, in case the LED malfunctions, the glass housing is prone to breakage if sufficient care is not taken in a replacement of the malfunctioned LED. Thus, a need for improvement exists.

### SUMMARY OF THE INVENTION

It is therefore one object of the invention to provide an LED lamp having an LED with two depending arms being formed integrally with a glass housing in a manufacturing process so that in case the LED lamp is malfunctioned, a replacement of both the LED and the glass housing can be made easy by removing from a socket.

The above and other objects, features and advantages of the invention will become apparent from the following detailed description taken with the accompanying drawings.

### BRIEF DESCRIPTION OF THE DRAWINGS

FIG. 1 is a sectional view of glass housing and LED of an LED lamp according to the invention;

FIG. 2 is an exploded view of the LED lamp including the glass housing, the LED, a leg, and a socket according to the invention before assembly;

FIG. 3 is a view similar to FIG. 2 where the LED lamp has been assembled;

FIG. 4 is a perspective view of a first preferred embodiment of LED lamp according to the invention;

FIG. 5 is a perspective view of a second preferred embodiment of LED lamp according to the invention;

FIG. 6 is a perspective view of a third preferred embodiment of LED lamp according to the invention;

FIG. 7 is a front view of FIG. 6; and

FIG. 8 is a side elevation of FIG. 6.

### DETAILED DESCRIPTION OF THE INVENTION

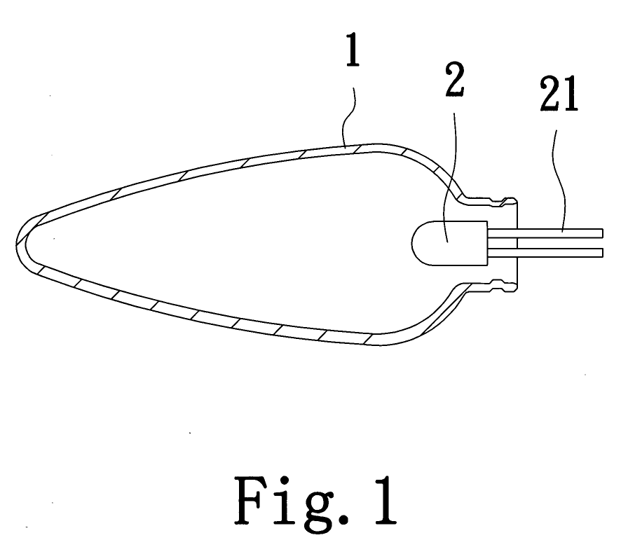

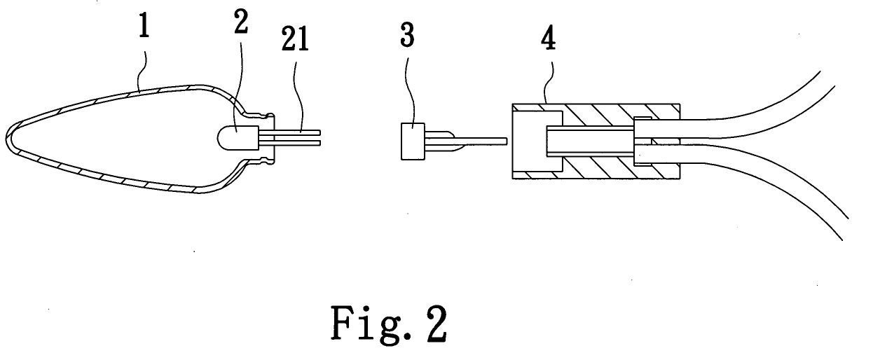

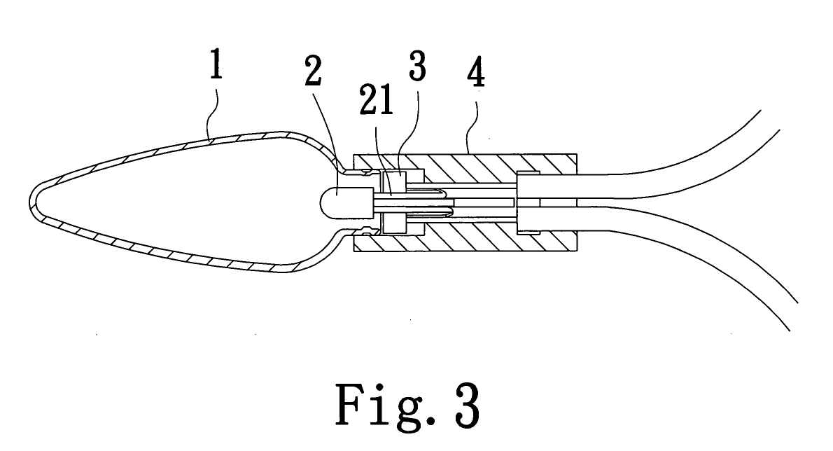

Referring to FIGS. 1 to 3, an LED lamp in accordance with the invention is shown. The LED lamp comprises the following components as discussed in detail below.

A housing 1 is formed of glass. An LED 2 as light source has two depending arms 21 extending therefrom. A leg 3 is shaped to secure to the depending arms 21 by inserting the depending arms 21 thereinto. An electrical socket 4 is shaped to secure to both the leg 3 and the base portion of the glass housing 1 by inserting the leg 3 thereinto. Thus, the socket 4 is electrically connected to the LED 2 via the leg 3 and the depending arms 21.

Preferably, the glass housing 1 and the depending arms 21 are formed integrally in a manufacturing process. Note that the LED 2 is prevented from directly contacting the glass housing 1. Otherwise, the LED 2 may be damaged by the melting glass. Hence, the yield of the LED lamp is high.

Preferably, in case the LED lamp is malfunctioned, a replacement of both the LED 2 and the glass housing 1 can be made easy by removing the base portion of the glass housing 1 from the socket 4 without worrying of breaking the glass housing 1.

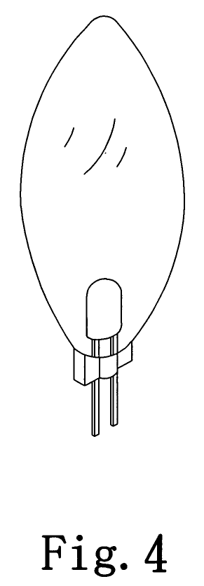

Referring to FIG. 4, a first preferred embodiment of LED lamp according to the invention is shown in which the glass housing is bulbous.

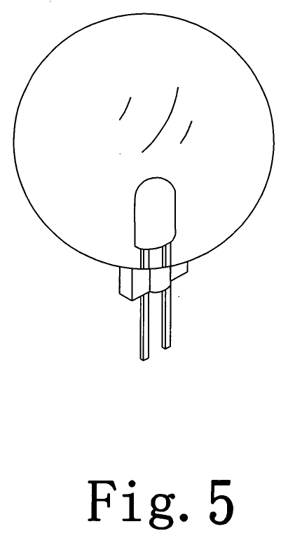

Referring to FIG. 5, a second preferred embodiment of LED lamp according to the invention is shown in which the glass housing is shaped as a globe.

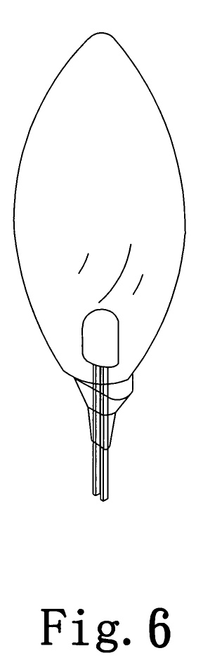

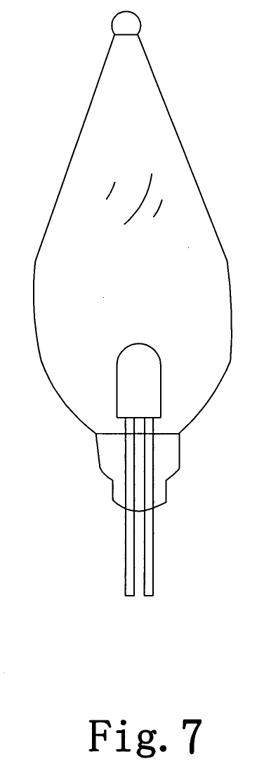

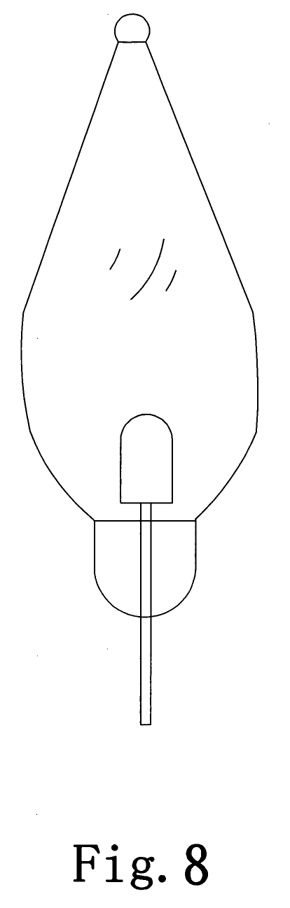

Referring to FIGS. 6 to 8, a third preferred embodiment of LED lamp according to the invention is shown in which the glass housing is also bulbous but has a base different from that shown in FIG. 4.

While the invention herein disclosed has been described by means of specific embodiments, numerous modifications and variations could be made thereto by those skilled in the art without departing from the scope and spirit of the invention set forth in the claims.

What is claimed is:

1. An LED light source comprising:
a housing formed of glass;
an LED having two depending arms extending therefrom;
a leg releasably secured to the depending arms; and
an electrical socket releasably secured to both the leg and a base portion of the housing,
wherein the housing and the depending arms are formed integrally.
